(19) United States
(12) Patent Application Publication
(10) Pub. No.: US 2009/0183223 A1
(43) Pub. Date: Jul. 16, 2009

(54) VIDEO DISTRIBUTION SYSTEM, VIDEO-RECORDING AND DISTRIBUTION APPARATUS, AND RECEIVER

(75) Inventors: Shinji MAEDA, Tokyo (JP); Junichi Yokosato, Tokyo (JP); Norihito Takatori, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/132,917

(22) Filed: Jun. 4, 2008

(30) Foreign Application Priority Data
Jan. 16, 2008 (JP) 2008-006864

(51) Int. Cl. H04N 7/173

(52) U.S. Cl. 725/145

(57) ABSTRACT

When carrying out reception and video-recording of a plurality of programs, a stream receiving unit (201) of a receiver (200) receives one of the plurality of programs, a recording unit (203) outputs a recording start request and a recording end request to a recording control unit (103) of a video-recording and distribution apparatus (102), a recording control unit (103) records a predetermined program according to the recording start request and the recording end request, and a download receiving unit (205) of the receiver (200) outputs a download start request after the stream receiving unit (201) ends the reception of the one of the plurality of programs to download recorded data of another one of the plurality of programs which are recorded by the video-recording and distribution apparatus (102). The receiver (200) thus limits the number of programs which it receives simultaneously to one.

### BACKGROUND OF THE INVENTION

1. Field of the Invention

The present invention relates to a video distribution system for digital broadcasting.

2. Description of Related Art

For example, patent reference 1 discloses, as a method of enabling a user to view and listen to a plurality of programs currently being broadcast simultaneously, a method of, in a conventional video distribution system in which a video distribution center broadcasts a program to one or more receivers via a network so that each user can view and listen to a broadcast program received by a receiver, collectively recording programs in the video distribution center, and providing a recorded program for each user via the network. Furthermore, patent reference 2 discloses a method of storing moving image data which a receiver has received in a recorder which is connected to the receiver via a network, and reading moving image data from the recorder according to a user's specification.

[Patent reference 1] JP, 2002-199318,A
[Patent reference 2] JP, 2005-20057,A

However, although patent reference 1 discloses a method for and a procedure for recording a program, patent reference 1 does not disclose any video-recording method of, in a case of enabling each user to view and listen to a plurality of programs, and recording them, taking into consideration the load on the network between the distribution center and the receiver at the time of distributing recorded data about the plurality of programs to the receiver, and any method of distributing the recorded data. A problem with the above-mentioned conventional video distribution system is therefore that in a case in which a user views and listens to or records a program distributed via the network by using one receiver, the network load increases when the receiver receives a plurality of streams simultaneously, and therefore a large network band is needed and this becomes a factor causing increase in the cost of the system.

Furthermore, because it is necessary to store the recorded data about a program which are recorded by the distribution center until the user who has made a request to record the program views and listens to the program, it is necessary to free up a large storage capacity for video-recording in the distribution center and this also becomes a factor causing increase in the cost of the system. A further problem is that both the network load at the time of distributing recorded data stored in a storage unit connected to the network to the receiver and a time period during which the recorded data are stored in the storage unit are dependent upon users.

### SUMMARY OF THE INVENTION

The present invention is made in order to solve the above-mentioned problems, and it is therefore an object of the present invention to provide a video distribution system which can implement distribution of a stream with stability while limiting the number of streams which are distributed from a distribution center comprised of a stream distribution apparatus and a video-recording and distribution apparatus to a receiver to one.

In accordance with the present invention, there is provided a video distribution system including a stream distribution apparatus which distributes a plurality of programs, a video-recording and distribution apparatus which records and distributes a predetermined program, a receiver which receives a program distributed by the stream distribution apparatus, and a network which connects the stream distribution apparatus, the video-recording and distribution apparatus, and the receiver with one another, in which the video-recording and distribution apparatus includes: a recording control unit for recording the predetermined program; and a download distribution unit for distributing recorded data about the predetermined program which are recorded by the recording control unit, and the receiver includes: a stream receiving unit for receiving a program distributed from the stream distribution apparatus; a playback unit for playing back the program; a recording unit for recording the program; a recorded data reading unit for reading recorded data about the program which are recorded by the recording unit; and a download receiving unit for downloading the recorded data recorded by the video-recording and distribution apparatus, and in which, when the video distribution system carries out reception and video-recording of a plurality of programs, the stream receiving unit receives one of the programs which is distributed from the stream distribution apparatus, the recording unit outputs either a request to start recording of another one of the programs or a request to end recording of the other program to the recording control unit, the recording control unit records the other program according to either the recording start request or the recording end request, and the download receiving unit outputs a request to start downloading the other program to the download distribution unit after the stream receiving unit completes the reception of the one program.

According to the present invention, while the receiver is receiving a predetermined program, the recording unit outputs a recording start request and a recording end request to the recording control unit, the recording control unit records the predetermined program according to the recording start request and the recording end request, and the download receiving unit outputs the download start request to the download distribution unit after the receiver completes the reception of the predetermined program. Thus, the system can record a plurality of programs while the receiver limits the number of programs which the receiver receives simultaneously to one program.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a video distribution system according to Embodiment 1 of the present invention;

FIG. 2 is a flow chart showing the operation of the video distribution system in accordance with Embodiment 1 of the present invention;

FIG. 3 is a diagram showing an example of a request and a response of the video distribution system in accordance with Embodiment 1 of the present invention;

FIG. 4 is a block diagram showing the structure of another example of the video distribution system in accordance with Embodiment 1 of the present invention;

FIG. 5 is a diagram showing in time sequence recorded data in a storage unit of the video distribution system in accordance with Embodiment 1 of the present invention;

FIG. 6 is a block diagram showing the structure of a video distribution system in accordance with Embodiment 2 of the present invention;

FIG. 7 is a flow chart showing the operation of the video distribution system in accordance with Embodiment 2 of the present invention;

FIG. 8 is a diagram showing data in a seamless playback control unit of the video distribution system in accordance with Embodiment 2 of the present invention;

FIG. 9 is a diagram showing an example of a request and a response of the video distribution system in accordance with Embodiment 2 of the present invention;

FIG. 10 is a block diagram showing the structure of a video distribution system in accordance with Embodiment 3 of the present invention;

FIG. 11 is a diagram showing an example of a network use band of the video distribution system in accordance with Embodiment 3 of the present invention;

FIG. 12 is a block diagram showing the structure of a video distribution system in accordance with Embodiment 4 of the present invention;

FIG. 13 is a diagram explaining the structure of a recorded data management unit of the video distribution system in accordance with Embodiment 4 of the present invention;

FIG. 14 is a diagram explaining the structure of the recorded data management unit of the video distribution system in accordance with Embodiment 4 of the present invention; and

FIG. 15 is a diagram explaining the structure of the recorded data management unit of the video distribution system in accordance with Embodiment 4 of the present invention.

### DETAILED DESCRIPTION OF THE PREFERRED EMBODIMENTS

### Embodiment 1

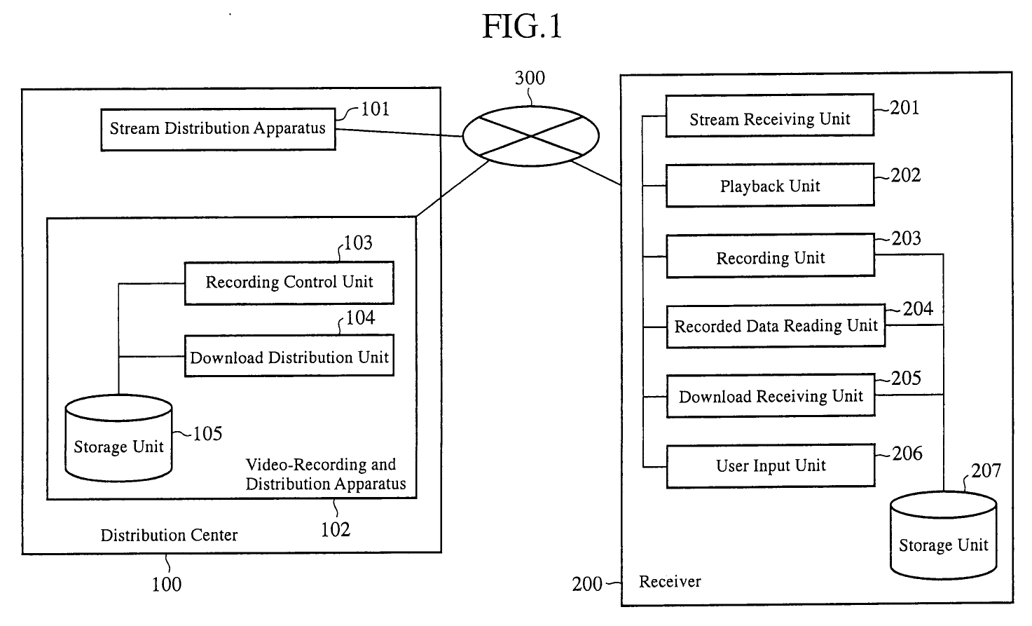

FIG. 1 is a block diagram showing the structure of a video distribution system in accordance with Embodiment 1 of the present invention. The video distribution system is comprised of a distribution center 100, a receiver 200, and a network 300 which connects the distribution center 100 with the receiver 200. The distribution center 100 is comprised of a stream distribution apparatus 101 and a video-recording and distribution apparatus 102. The stream distribution apparatus 101 distributes a stream of one or more programs by way of the network 300. Concretely, the stream distribution apparatus 101 encodes data about a video and an audio of a program, or the like by using a coding method such as an H.264 coding method or an MPEG-2 coding method, packetizes the coded data into IP packets, and distributes these IP packets as a stream via the network 300.

The video-recording and distribution apparatus 102 is comprised of a recording control unit 103, a download distribution unit 104, and a storage unit 105. According to a request inputted from the receiver 200, the recording control unit 103 receives a stream of a program which is distributed by the stream distribution apparatus 101 and the recorder 105 then stores the stream as recorded data. The storage unit 105 is comprised of, for example, a hard disk drive. The recording control unit 103 can delete the headers of the IP packets from the stream of the program which the recording control unit has received, and can store, as recorded data, only the coded data about the video, the audio, etc. of the program. According to a request inputted from the receiver 200, the download distribution unit 104 distributes the recorded data which the recording control unit 103 has stored in the storage unit 105 to the receiver 200.

The receiver 200 is comprised of a stream receiving unit 201, a playback unit 202, a recording unit 203, a recorded data reading unit 204, a download receiving unit 205, a user input unit 206, and a storage unit 207. The stream receiving unit 201 receives the stream of the program which is distributed from the stream distribution apparatus 101 included in the distribution center 100, and outputs the received stream to either the playback unit 202 or the recording unit 203. The playback unit 202 decodes the stream inputted from the stream receiving unit 201 into data about the video, the audio, etc. by using a coding method such as an H.264 coding method or an MPEG-2 coding method, and then plays back the data.

The recording unit 203 records a program according to a user's instruction inputted from the user input unit 206. In this embodiment, there can be the following two methods of recording a program: a method of recording a program in the storage unit 207 included in the receiver 200; and a method of recording a program in the storage unit 105 included in the video-recording and distribution apparatus 102 of the distribution center 100. In the case of recording a stream of a program in the receiver 200, the stream of the program which the stream receiving unit 201 has received is inputted to the recording unit 203 and is then recorded in the storage unit 207. In contrast, in the case of recording a program in the distribution center 100, when the recording unit 203 transmits a recording start request to the distribution center 100, a video-recording command for recoding the program is inputted to the recording control unit 103 and the program is then recorded in the storage unit 105.

The recorded data reading unit 204 reads the recorded data about the program recorded in the storage unit 207, and outputs the recorded data to the playback unit 202. The download receiving unit 205 downloads the recorded data about the program recorded in the distribution center 100. The receiver performs the download of the recorded data by transmitting a download start request to the download distribution unit 104 of the distribution center 100.

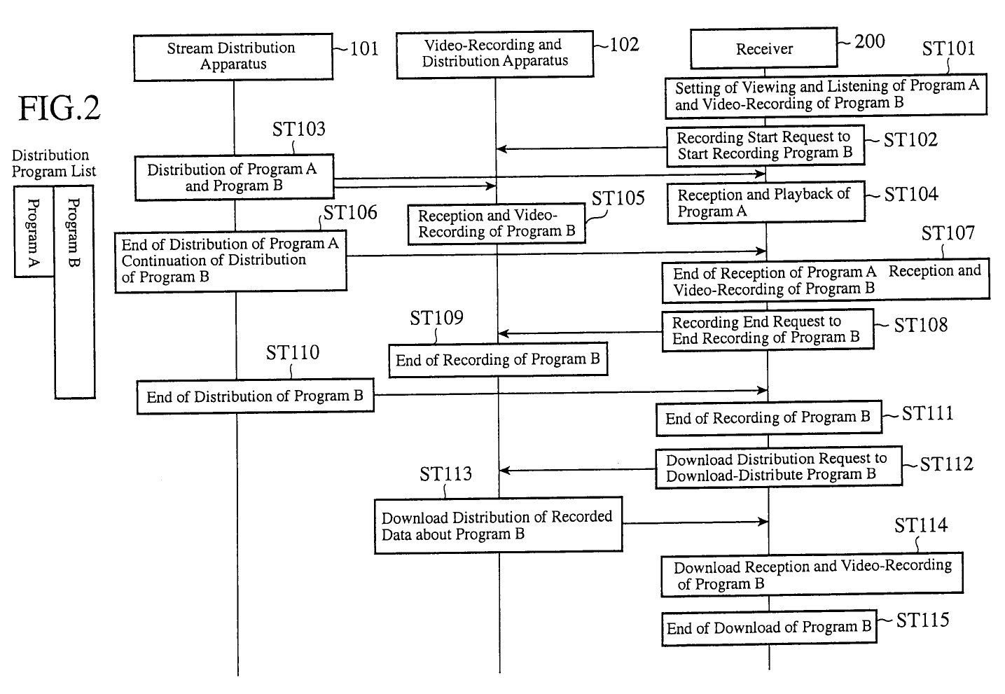

Next, the operation of the video distribution system in accordance with Embodiment 1 of the present invention will be explained. FIG. 2 is a flow chart showing the operation of the video distribution system in accordance with Embodiment 1 of the present invention. Hereafter, a case in which the stream distribution apparatus 101 of the distribution center 100 distributes a program A and a program B simultaneously, and the user of the receiver 200 views and listens to both of the programs will be explained as an example with reference to the flow chart of FIG. 2.

The user of the receiver 200 inputs a setting command for viewing and listening to the program A and recording the program B via the user input unit 206 (step ST101). In step ST101, the recording unit 203 which has received the recording setting command transmits a recording start request to start video-recording of the program B to the video-recording and distribution apparatus 102 (step ST102). When the distribution start time of the programs A and B comes, the stream distribution apparatus 101 starts the distribution of the programs A and B (step ST103). The stream receiving unit 201 starts reception of the stream of the program A which the stream distribution apparatus starts distributing in step ST103, and outputs the stream received to the playback unit 202, so that the playback unit 202 plays back the program A (step ST104). On the other hand, the video-recording and distribution apparatus 102 to which the recording start request is transmitted in step ST102 starts video-recording of the program B by using the recording control unit 103 (step ST105).

When the distribution end time of the program A comes, the stream distribution apparatus 101 ends the distribution of the program A (step ST106). The receiver 200 then ends the reception and playback of the program A, and starts reception and video-recording of the program B. More specifically, the stream receiving unit 201 ends the reception of the program A and starts reception of the program B, and outputs the stream of the program B which the stream receiving unit has received to the recording unit 203, and the recording unit 203 then records the stream of the program B in the storage unit 207 (step ST107). The recording unit 203 further outputs a recording end request to end the recording of the program B to the video-recording and distribution apparatus 102 in order to end the video-recording of the program B using the recording control unit 103 (step ST108). The video-recording and distribution apparatus 102 ends the video-recording of the program B using the recording control unit 103 according to the recording end request transmitted thereto in step ST108 (step ST109). When the distribution end time of the program B comes, the stream distribution apparatus 101 ends the distribution of the program B (step ST110), the stream receiving unit 201 ends the reception of the program B, and the recording unit 203 ends the video-recording of the program B (step ST111).

Next, the download receiving unit 205 outputs a download distribution request to download the recorded data about the program B recorded in the storage unit 105 of the video-recording and distribution apparatus 102 (step ST112). The video-recording and distribution apparatus 102 carries out download distribution of the recorded data about the program B by using the download distribution unit 104 according to the download distribution request outputted thereto in step ST112 (step ST113). The download receiving unit 205 receives the recorded data about the program B distributed from the video-recording and distribution apparatus 102 and then outputs the received recorded data to the recording unit 203, and the recording unit 203 stores the recorded data in the storage unit 207 (step ST114).

In this case, because the stream of the latter half of the program B is already stored, as recorded data, in the storage unit 207, the stream of the first half of the program B recorded in the distribution center 100 is stored, as other recorded data, in the storage unit 207. As a method of storing the stream of the program B in the storage unit 207, there can be, for example, a method of combining the file of the first half recorded in the distribution center 100 and the file of the latter half recorded in the receiver 200, and then storing the combined fines as one stream, or a method of storing both the file of the first half and the file of the latter half separately, and then making the recorded data reading unit 204 read the stream of the latter half to start a playback of the latter half after completing a playback of the first half.

When the download receiving unit 205 completes the download of the program B (step ST115), the receiver 200 records the whole of the program B in the storage unit 207. As a result, the receiver 200 enables the user to view and listen to the program B. After completing the download distribution of the recorded data about the program B to the receiver 200, the video-recording and distribution apparatus 102 can delete the recorded data.

After the system carries out the series of processes in steps ST101 to ST115 as mentioned above, and the user of the receiver 200 views and listens to the program A, the user can view and listen to the program B recorded in the receiver 200. In this case, the receiver 200 receives only the program A in steps ST104 to ST107, receives only the program B in steps ST107 to ST111, and receives only the program B in steps ST114 and ST115. The receiver 200 can thus enable the user to view and listen to the program A and record the program B while limiting the number of programs which the receiver 200 receives simultaneously to one.

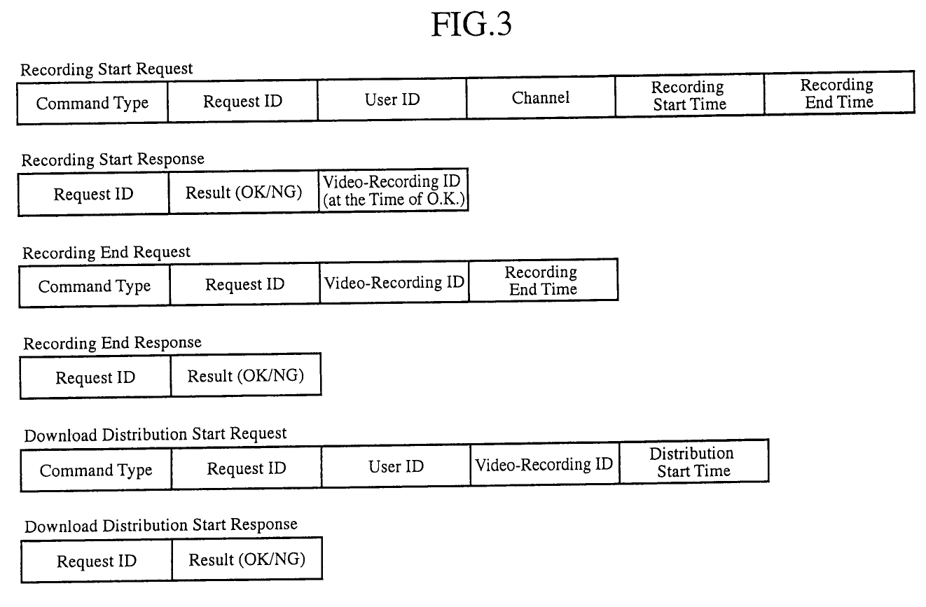

Next, an example of the recording start request and the recording end request which are transmitted from the recording unit 203 of the receiver 200 to the video-recording and distribution apparatus 102, the download distribution start request which is transmitted from the download receiving unit 205 to the video-recording and distribution apparatus 102, and a recording start response, a recording end response, and a download distribution start response which are transmitted respectively from the video-recording and distribution apparatus 102 to the receiver 200 in response to the above-mentioned requests will be shown with reference to FIG. 3.

As shown in FIG. 3, the recording start request which the recording unit 203 transmits has a specified format consisting of a command type indicating that the request is a recording start request, a request ID which stores an ID (e.g., a user ID+a serial number) for identifying the request uniquely, a user ID, a channel, a recording start time, and a recording end time. By using the recording start request having this format, the recording unit 203 makes a request of the video-recording and distribution apparatus 102 to start recording a program. The recording unit 203 does not necessarily need to specify the recording end time in the recording start request, and can alternatively transmit the recording end request separately. The video-recording and distribution apparatus 102 to which the recording start request is inputted answers, as a recording start response to the recording start request, the request ID stored in the recording start request, a result showing whether to accept the recording start request, and, when the result indicates O.K. (acceptance), a recording ID which the video-recording and distribution apparatus has uniquely generated for the recording start request to the recording unit 203.

The recording end request which the recording unit 203 transmits has a specified format consisting of a command type indicating that the request is a recording end request, a request ID, a recording ID, and a recording end time. By using the recording end request having this format, the recording unit 203 makes a request of the video-recording and distribution apparatus 102 to end the recording. The video-recording and distribution apparatus 102 to which the recording end request is inputted answers, as a recording end response to the recording end request, the request ID stored in the recording end request and a result indicating whether to accept the recording end request to the recording unit 203. The download distribution start request which the download receiving unit 205 transmits has a specified format consisting of a command type indicating that the request is a download distribution start request, a request ID, a user ID, a recording ID, and a distribution start time. By using the recording end request having this format, the download receiving unit 205 makes a request of the video-recording and distribution apparatus 102 to start download distribution. The video-recording and distribution apparatus 102 to which the download distribution starting request is inputted answers, as a download distribution start response to the download distribution start request, the request ID stored in the download distribution start request and a result indicating whether to accept the download distribution start request to the download receiving unit 205.

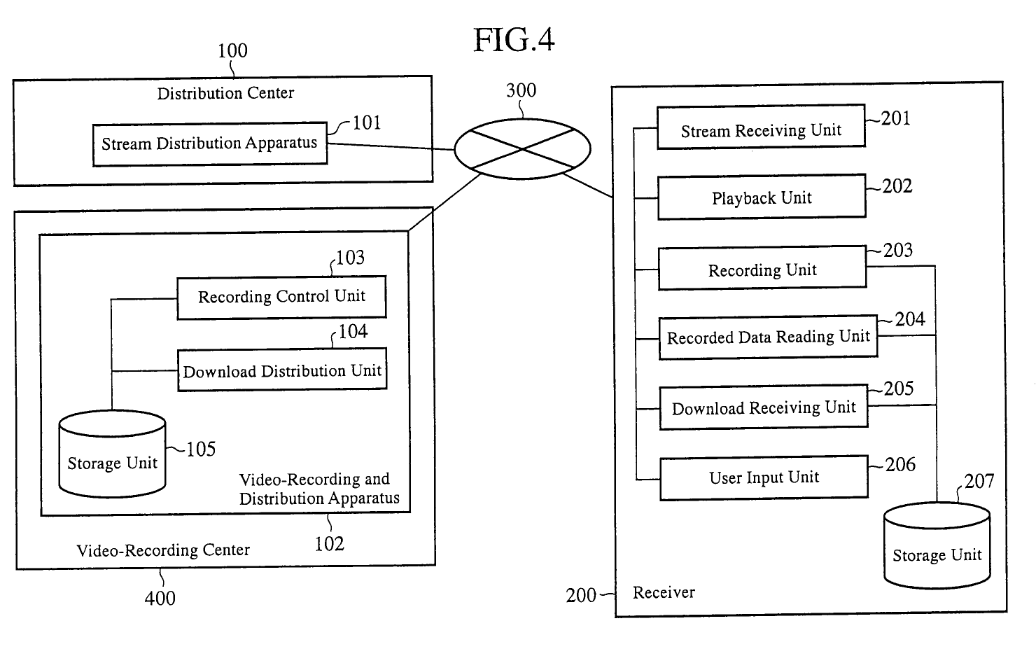

FIG. 4 is a block diagram showing the structure of a variant of the video distribution system in accordance with Embodiment 1 of the present invention. In FIG. 1, the example in which the video-recording and distribution apparatus 102 is disposed in the distribution center 100 is shown. In contrast, in accordance with this variant, the video-recording and distribution apparatus 102 can be disposed in a video-recording center 400 connected, via the network 300, to the distribution center 100, as shown in FIG. 4. Also in this case, while the user of the receiver 200 is viewing and listening to the program A by using the receiver 200, the video-recording and distribution apparatus 102 included in the video-recording center 400 records the program B in the same way that the video-recording and distribution apparatus shown in FIG. 1 operates as mentioned above, and, after the user of the receiver 200 finishes viewing and listening to the program A, the receiver 200 enables the user to view and listen to the program B recorded therein by downloading the recorded data about the program B from the video-recording and distribution apparatus 102.

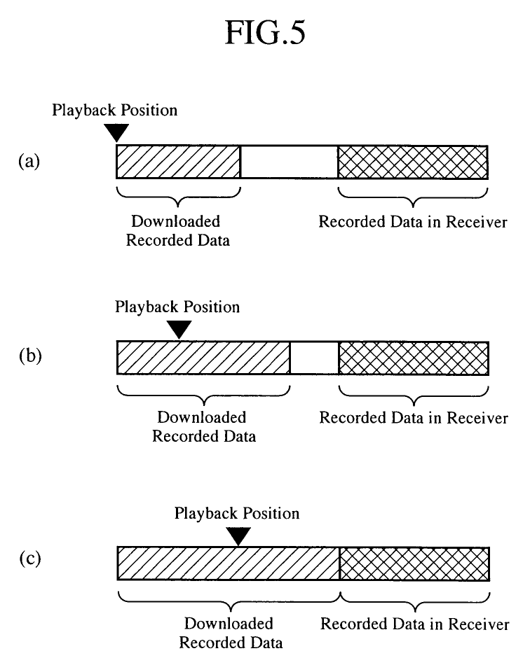

FIGS. 5(a) to 5(b) are diagrams showing in time sequence recorded data in the storage unit of the video distribution system in accordance with Embodiment 1 of the present invention, and show the positions of playback of the recorded data and a state in which the download of the recorded data is in process. In the above-mentioned explanation, the example in which the receiver 200 enables the user to start viewing and listening to the program B after the download of the program B is completed and the whole of the program B is recorded in the storage unit 207 included in the receiver 200 is shown. As an alternative, the receiver can play back the program B so as to make the user start viewing and listening to the program B during the download of the program B, as shown in FIG. 5(a). Because the recorded data about the program B are recorded in the storage unit 207 from the head of the program B after the download of the program B is started, the receiver can play back the program B from the head of the program B. Furthermore, the download of the recorded data about the program B also advances during the playback of the program B (refer to FIG. 5(b)), and the download of the program B is completed during the playback of the program B (refer to FIG. 5(c)). As a result, the user can view and listen to the program B recorded in the receiver 200 continuously.

However, in a case in which the transfer rate at which the receiver plays back the program is higher than the transfer rate which the receiver downloads the program, if the playback start time of the program is too early, an underflow of the recorded data occurs and the playback of the program becomes discontinuous. Therefore, the time t at which the receiver starts a playback of the program after starting downloading the program is calculated from the transfer rate p of the download, the transfer rate q of the playback, and the size r of the recorded data about the program to be downloaded according to the following equation 1:

t=r/p−r/q(q>p), t=0(q<=p) (equation 1)

As mentioned above, in accordance with Embodiment 1 of the present invention, while the receiver receives a predetermined program, another program is recorded into the storage unit of the distribution center, and, after the receiver finishes the reception of the program, the receiver downloads the recorded data about the other program from the distribution center by using the download distribution unit, and records the recorded data therein. Therefore, after the user of the receiver finishes viewing and listening to the predetermined program, the user can view and listen to the other program recorded in the receiver. Thus, the system can record a plurality of programs while the receiver limits the number of programs which the receiver receives simultaneously to one program.

Furthermore, in accordance with Embodiment 1 of the present invention, the distribution center records only a part of the other program including from the head of this program only during a period of time which elapses until the distribution of the predetermined program which the receiver is receiving is completed. Therefore, as compared with a case in which the whole of the other program to be recorded is recorded in the distribution center, the capacity of the storage unit of the distribution center can be reduced. In addition, because the receiver automatically downloads the recorded data recorded in the storage unit of the distribution center when not receiving any stream, it is not necessary to store the recorded data recorded in the storage unit of the distribution center for a long time and it is therefore possible to use the storage unit efficiently and to reduce the cost of the system.

Furthermore, in accordance with Embodiment 1 of the present invention, while the receiver is receiving a program other than programs to be recorded and the load on the network is high, the distribution center records another program to be recorded and, after that, when the load on the network becomes low, the receiver receives the recorded data about the other program from the distribution center automatically. Therefore, the user of the receiver can view and listen to a plurality of programs which are broadcast simultaneously with an easy operation. In addition, in a case in which the video-recording done by the distribution center is a pay service, because the amount of storage in the distribution center which the user uses to record a desired program and the time required for the user to use the storage unit to record the desired program can be minimized, the charge for the use of the distribution center which increases in proportion to the used amount of and the usage time of storage of the distribution center can be reduced.

### Embodiment 2

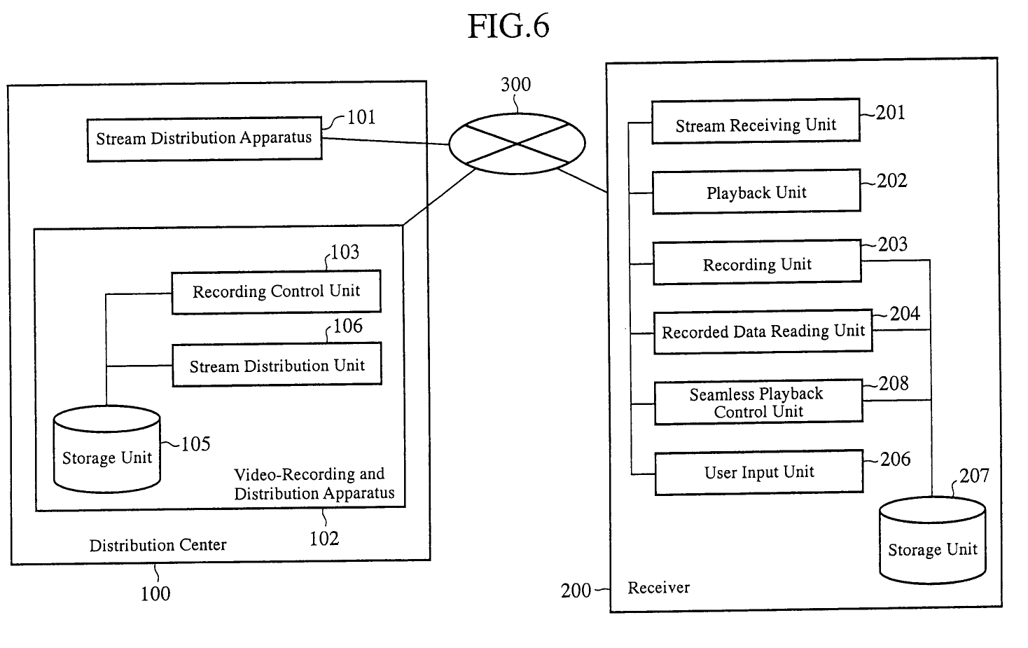

FIG. 6 is a block diagram showing the structure of a video distribution system in accordance with Embodiment 2 of the present invention. In this video distribution system, instead of the download distribution unit 104 included in the distribution center 100 and the download receiving unit 205 included in the receiver 200 in the video distribution system in accordance with Embodiment 1, a stream distribution unit 106 and a seamless playback control unit 208 are disposed. The same components as those of the video distribution system in accordance with Embodiment 1 or like components are designated by the same reference numerals as those shown in Embodiment 1, and the explanation of those components will be omitted or simplified hereafter. The stream distribution unit 106 stream-distributes recorded data about a program which are stored in the storage unit 105 according to a request from the receiver 200. When continuously playing back both the recorded data recorded by the distribution center 100 and the recorded data recorded in the receiver 200, the seamless playback control unit 208 performs a control operation to play back them seamlessly.

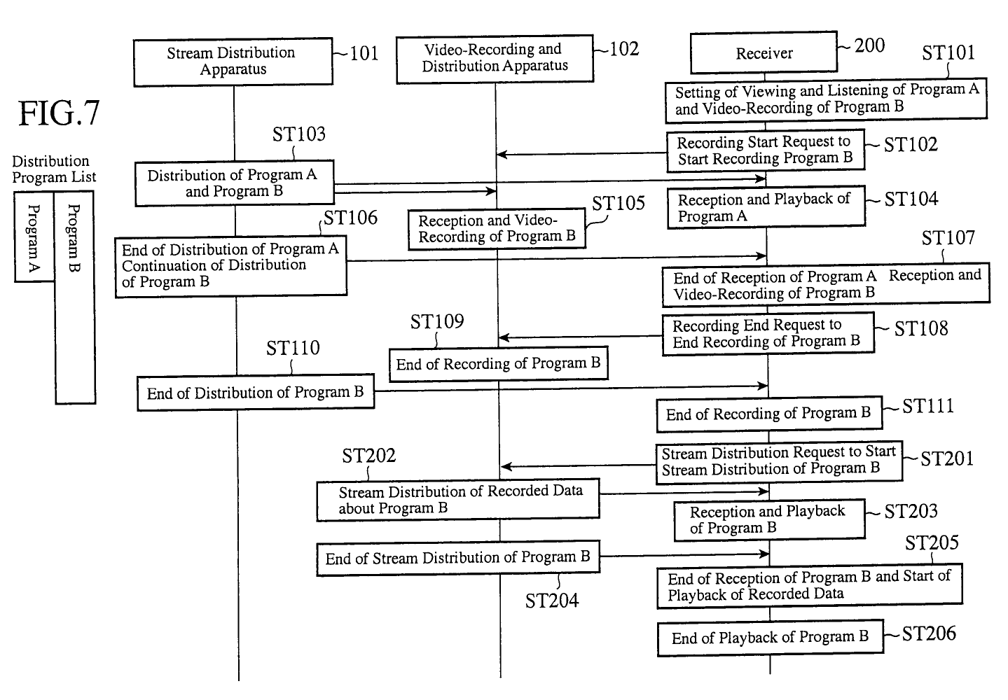

Next, the operation of the video distribution system in accordance with Embodiment 2 of the present invention will be explained. FIG. 7 is a flow chart showing the operation of the video distribution system in accordance with Embodiment 2 of the present invention. Hereafter, a case in which the stream distribution apparatus 101 of the distribution center 100 distributes a program A and a program B simultaneously, and the user of the receiver 200 views and listens to both of the programs will be explained as an example with reference to FIG. 7. The same reference characters as ST101 to ST111 used in FIG. 2 are given to the steps in which the video distribution system in accordance with Embodiment 2 performs the same processes as those performed by the video distribution system in accordance with Embodiment 1, respectively, and the explanation of the processes will be omitted hereafter.

After the receiver 200, in step ST111, completes the reception and video-recording of the program B, the seamless playback control unit 208 transmits a stream distribution start request to start distribution of a stream of the recorded data about the program B recorded in the video-recording and distribution apparatus 102 (step ST201). The video-recording and distribution apparatus 102 stream-distributes the recorded data about the program B by using the stream distribution unit 106 according to the stream distribution start request transmitted in step ST201 (step ST202). When the seamless playback control unit 208 receives the recorded data about the program B distributed from the video-recording and distribution apparatus 102, the seamless playback control unit 208 outputs the recorded data to the playback unit 202 and the playback unit 202 then plays back the recorded data about the program B (step ST203).

After the video-recording and distribution apparatus 102 completes the distribution of the stream of the recorded data about the program B (step ST204), the seamless playback control unit 208 included in the receiver 200 ends the reception of the stream of the program B, and, in order to continue to play back the recorded data about the program B recorded within the receiver 200 in steps S107 to S111, reads the recorded data about the program B via the recorded data reading unit 204, and outputs the recorded data to the playback unit 202. The playback unit 202 then plays back the recorded data about the program B (step ST205). After that, the playback unit 202 completes the playback of the recorded data about the program B (step ST206).

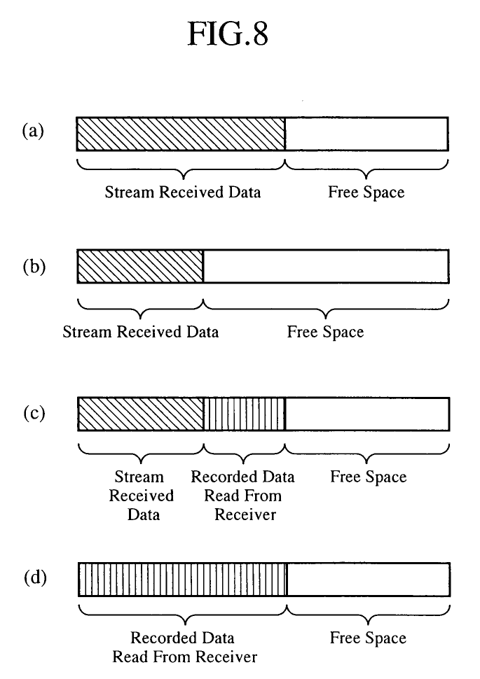

FIGS. 8(a) to 8(d) are diagrams showing the status of data in the seamless playback control unit of the video distribution system in accordance with Embodiment 2 of the present invention. FIGS. 8(a) to 8(d) shows the status of data in the seamless playback control unit in a case in which the playback unit 202 plays back both the recorded data in the distribution center 100 and the recorded data in the receiver 200 seamlessly. In this case, the data are stored in a buffer of the seamless playback control unit in such a way that the data are sequentially running from the head of the buffer on the left side of the figure, and the data are sequentially delivered to the playback unit 202 in the order in which they are stored in the buffer. FIG. 8(a) shows a state in which the seamless playback control unit 208 is receiving the stream of the program B from the distribution center 100, and is playing back the stream. Therefore, only the stream which the seamless playback control unit 208 has received is stored in the buffer of the seamless playback control unit 208. FIG. 8(b) shows a state immediately before the seamless playback control unit 208 ends the reception and playback of the stream. In this state, the reception of the stream is stopped and the free space of the buffer increases.

FIG. 8(c) shows a state immediately before the seamless playback control unit 208 ends the reception and playback of the stream. When the seamless playback control unit 208 does not receive the stream during a fixed period of time, the seamless playback control unit 208 judges that the distribution of the stream is completed and starts reading the recorded data stored in the receiver 200. As a result, the playback unit 202 can play back both the recorded data in the distribution center 100 and the recorded data in the receiver 200 seamlessly. FIG. 8(d) shows a state in which the seamless playback control unit 208 is playing back the recorded data in the receiver 200.

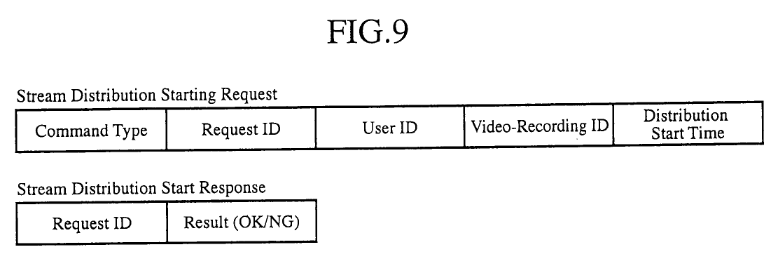

Next, an example of a stream distribution start response which the video-recording and distribution apparatus 102 transmits to the receiver 200 in response to the stream distribution start request which is transmitted from the seamless playback control unit 208 of the receiver 200 to the video-recording and distribution apparatus 102 will be shown with reference to FIG. 9. As shown in FIG. 9, the stream distribution start request which the seamless playback control unit 208 transmits has a specified format consisting of a command type indicating that the request is a stream distribution start request, a request ID which stores an ID (e.g., a user ID+a serial number) for identifying the request uniquely, a user ID, a recording ID, and a recording start time. By using the stream distribution start request having this format, the seamless playback control unit 208 makes a request of the video-recording and distribution apparatus 102 to start distribution of the stream. The video-recording and distribution apparatus 102 to which the stream distribution start request is inputted answers both the request ID stored in the stream distribution start request and a result indicating whether to accept the stream distribution start request as a stream distribution start response.

As mentioned above, the video distribution system according to Embodiment 2 of the present invention includes the stream distribution unit for stream-distributing recorded data about a program, and the seamless playback control unit for performing a control operation to play back both the recorded data distributed by the stream distribution unit and recorded data in the receiver seamlessly. Therefore, the video distribution system can play back both the recorded data distributed by the stream distribution unit and recorded data in the receiver seamlessly. Furthermore, the user of the receiver can view and listen to both a program recorded in the distribution center and a program recorded in the receiver after viewing and listening to a predetermined program.

In above-mentioned Embodiment 2, the example in which the video-recording and distribution apparatus 102 is disposed in the distribution center 100 is shown. As an alternative, as in the case of FIG. 4 shown in Embodiment 1, the video-recording and distribution apparatus 102 can be disposed in a video-recording center 400.

### Embodiment 3

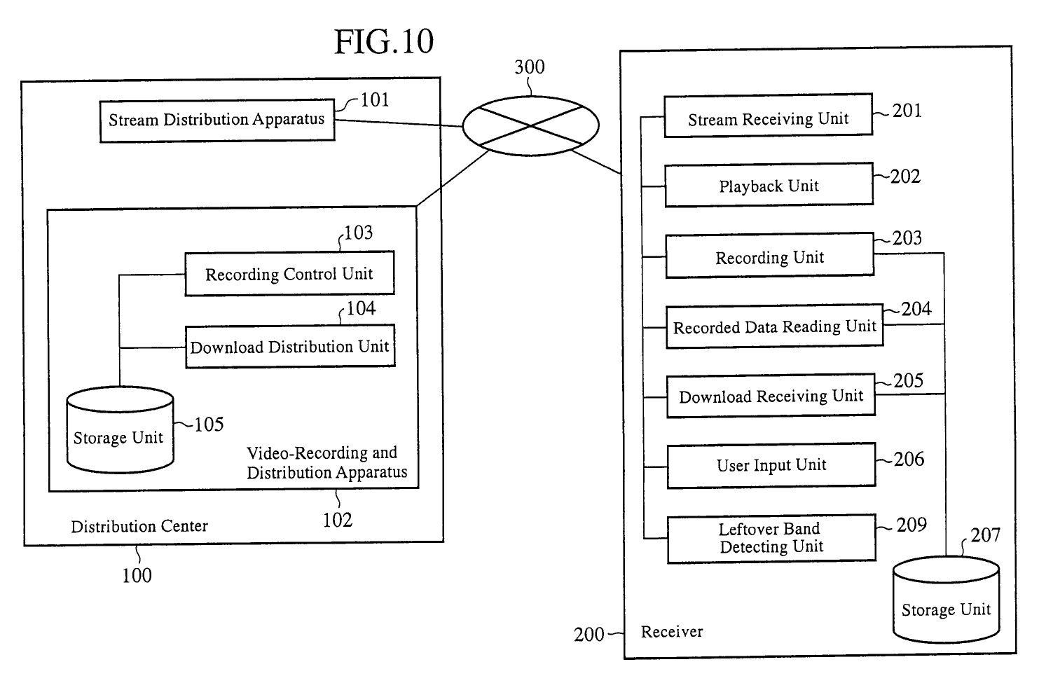

FIG. 10 is a diagram showing the structure of a video distribution system in accordance with Embodiment 3 of the present invention. In this video distribution system, a leftover band detecting unit 209 is added to the receiver 200 in accordance with Embodiment 1. The same components as those of the video distribution system in accordance with Embodiment 1 or like components are designated by the same reference numerals as those shown in Embodiment 1, and the explanation of those components will be omitted or simplified hereafter. The leftover band detecting unit 209 measures the usage band of the network 300 from the amount of data which the stream receiving unit 201 receives per unit time, and, when a leftover band exists in the network 300, uses the leftover band of the network 300 and controls the download receiving unit 205 so as to carry out download reception of recorded data recorded in the distribution center 100.

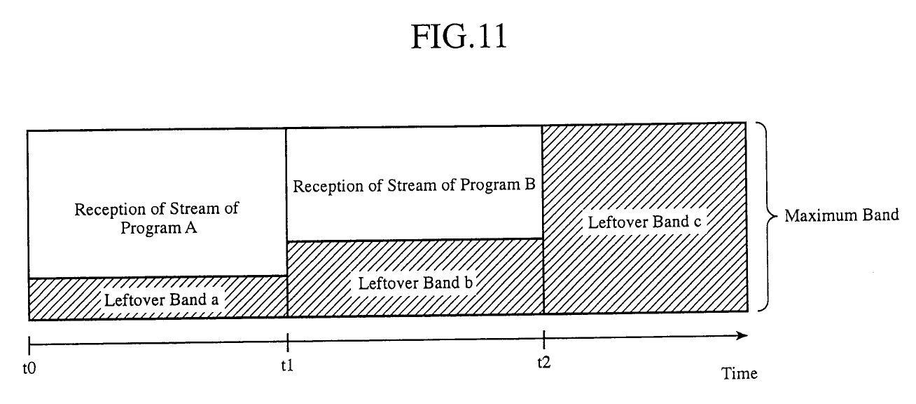

FIG. 11 is a diagram showing an example of the network usage band of the video distribution system in accordance with Embodiment 3 of the present invention. In the example shown in FIG. 11, the stream receiving unit 201 is receiving a stream of a program A having a large usage band of the network 300 during a period of time from a time t0 to a time t1, and the leftover band is a. Furthermore, the stream receiving unit 201 is receiving a stream of a program B having a small usage band of the network 300 during a period of time from the time t1 to a time t2, and the leftover band is b. In addition, because the stream receiving unit 201 does not receive any stream after the time t2, the leftover band is c (=a maximum band). The leftover band detecting unit 209 controls the reception of the stream according to change in the leftover band by detecting the leftover band of the network 300 at regular intervals.

For example, when the receiver 200 downloads a program C under the usage of the network 300 as shown in FIG. 11, the stream receiving unit 201 can download the program C by using either the leftover band a or the leftover band b even during the time period from the time t0 to the time t2 during which the stream receiving unit 201 is receiving either the program A or the program B. More specifically, during the time period from the time t0 to the time t1, the stream receiving unit 201 performs control and reception in such a way that the receiving speed for downloading the program C falls within the leftover band a while receiving the stream of the program A. Similarly, during the time period from the time t1 to the time t2, the stream receiving unit 201 performs control and reception in such a way that the receiving speed for downloading the program C falls within the leftover band b while receiving the stream of the program B, and, after the time t2, the stream receiving unit 201 performs control and reception in such a way that the receiving speed for downloading the program C falls within the leftover band c.

As mentioned above, the video distribution system according to this Embodiment 3 includes the leftover band detecting unit for measuring a leftover band which exists in the network, and carries out download reception of recorded data recorded in the distribution center using the leftover band. Therefore, even if the user of the receiver is viewing and listening to a program or the receiver is recording a program, the receiver can download another program when a leftover band exists in the network.

### Embodiment 4

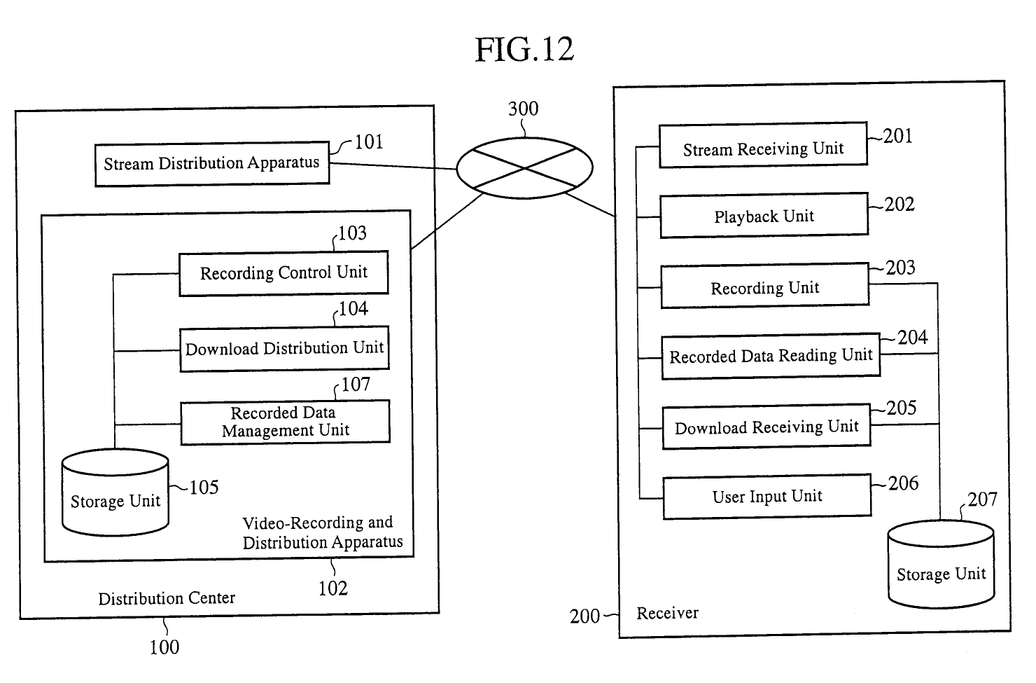

FIG. 12 is a diagram showing the structure of a video distribution system in accordance with Embodiment 4 of the present invention. In this video distribution system, a recorded data management unit 107 is added to the distribution center 100 in accordance with Embodiment 1. The same components as those of the video distribution system in accordance with Embodiment 1 or like components are designated by the same reference numerals as those shown in Embodiment 1, and the explanation of those components will be omitted or simplified hereafter. The recorded data management unit 107, in response to a recording start request inputted from the receiver 200, performs a control operation so as to manage recorded data which the recording control unit 103 has stored in the storage unit 105.

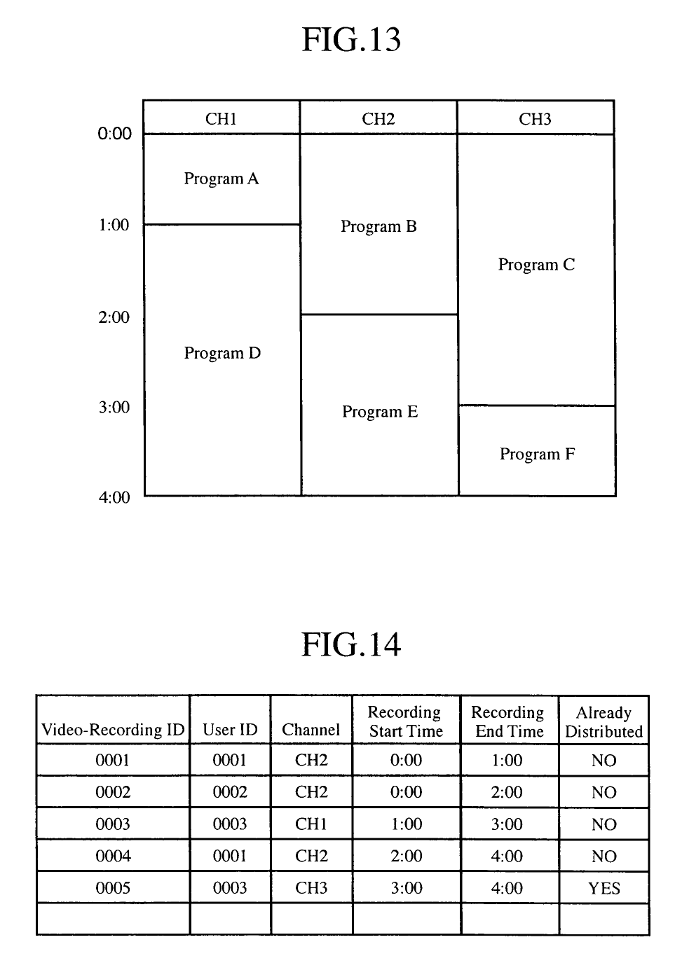

The structure of the recorded data management unit 107 will be explained with reference to FIGS. 13 to 15. FIG. 13 shows an example of a program list which is used for explanation of the video distribution system in accordance with Embodiment 4 of the present invention. Concretely, this program list shows that a program A will be distributed during a time period of 0:00 to 1:00 via CH1 and a program D will be distributed during a time period of 1:00 to 4:00 via CH1, a program B will be distributed during a time period of 0:00 to 2:00 via CH2 and a program E will be distributed during a time period of 2:00 to 4:00 via CH2, and a program C will be distributed during a time period of 0:00 to 3:00 via CH3 and a program F is distributed during a time period of 3:00 to 4:00 via CH3.

FIG. 14 shows an example of a recorded data control table which the recorded data management unit of the video distribution system in accordance with Embodiment 4 of the present invention manages. Concretely, the recorded data control table shows that the user of the user ID 0001 will record a program transmitted via CH2 during a time period of 0:00 to 1:00 and will record a program transmitted via CH2 during a time period of 2:00 to 4:00, the user of the user ID 0002 will record a program transmitted via CH2 during a time period of 0:00 to 2:00, and the user of the user ID 0003 will record a program transmitted via CH1 during a time period of 1:00 to 3:00 and will record a program transmitted via CH3 during a time period of 3:00 to 4:00. In a column: “Already Distributed”, data indicating whether corresponding recorded data have been distributed to the receiver 200 are stored. In the example of FIG. 14, the recorded data of the recording ID 0005 have been distributed to the user of the user ID 0003, and therefore it is not necessary to store the recorded data of the recording ID0005.

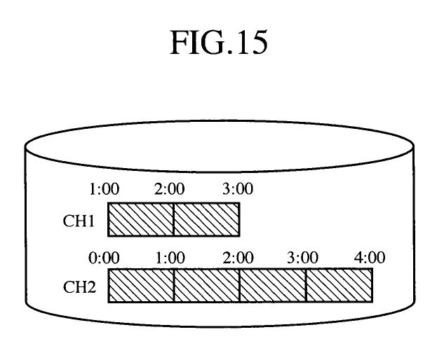

Recorded data which are actually stored in the storage unit 105 of the video-recording and distribution apparatus 102 when the receiver 200 has made program vide-recording requests as shown in FIG. 14 are shown in FIG. 15. When there are video-recording requests in which their channels and recording time zones overlap one another, the recorded data management unit 107 carries out a management process in such a way as to store recorded data about only one of them in the storage unit 105. More specifically, in the example of FIG. 14, because the recording request of the video-recording ID 0001 partially coincides with the recording request of the video-recording ID 0002 during the time period of 0:00 to 1:00 with respect to CH2, the recorded data management unit 107 actually stores recorded data about the program transmitted via CH2 during the time period of 0:00 to 2:00. The recorded data management unit 107 deletes the recorded data which have been distributed in response to the download request from the download receiving unit 205 of the receiver 200 from the storage unit 105.

As mentioned above, because the video distribution system according to Embodiment 4 of the present invention is provided with the recorded data management unit for managing video-recording requests in which their channels and recording time zones overlap one another as a single video-recording request, the amount of recorded data which are stored in the storage unit can be reduced to a minimum.

Many widely different embodiments of the present invention may be constructed without departing from the spirit and scope of the present invention. It should be understood that the present invention is not limited to the specific embodiments described in the specification, except as defined in the appended claims.

What is claimed is:

1. A video distribution system including a stream distribution apparatus which distributes a plurality of programs, a video-recording and distribution apparatus which records and distributes a predetermined program, a receiver which receives a program distributed by said stream distribution apparatus, and a network which connects said stream distribution apparatus, said video-recording and distribution apparatus, and said receiver with one another, wherein
said video-recording and distribution apparatus comprises:
a recording control unit for recording the predetermined program; and a download distribution unit for distributing recorded data about the predetermined program which are recorded by said recording control unit, and
said receiver comprises:
a stream receiving unit for receiving a program distributed from said stream distribution apparatus;
a playback unit for playing back said program;
a recording unit for recording said program;
a recorded data reading unit for reading recorded data about said program which are recorded by said recording unit; and
a download receiving unit for downloading the recorded data recorded by said video-recording and distribution apparatus,
and wherein, when said video distribution system carries out reception and video-recording of a plurality of programs, said stream receiving unit receives one of the programs which is distributed from said stream distribution apparatus, said recording unit outputs either a request to start recording of another one of the programs or a request to end recording of said other program to said recording control unit, said recording control unit records said other program according to either said recording start request or said recording end request, and said download receiving unit outputs a request to start downloading said other program to said download distribution unit after said stream receiving unit completes the reception of said one program.

2. The video distribution system according to claim 1, wherein both said stream distribution apparatus and said video-recording and distribution apparatus are arranged in a distribution center.

3. The video distribution system according to claim 1, wherein said stream distribution apparatus is arranged in a distribution center and said video-recording and distribution apparatus is arranged in a video-recording center.

4. The video distribution system according to claim 1, wherein said video-recording and distribution apparatus includes a stream distribution unit for stream-distributing the recorded data recorded by said recording control unit, and said receiver includes a seamless playback unit for buffering both the recorded data distributed by said stream distribution unit and the recorded data recorded by said recording unit, and for continuously playing back them.

5. The video distribution system according to claim 2, wherein said video-recording and distribution apparatus includes a stream distribution unit for stream-distributing the recorded data recorded by said recording control unit, and said receiver includes a seamless playback unit for buffering both the recorded data distributed by said stream distribution unit and the recorded data recorded by said recording unit, and for continuously playing back them.

6. The video distribution system according to claim 3, wherein said video-recording and distribution apparatus includes a stream distribution unit for stream-distributing the recorded data recorded by said recording control unit, and said receiver includes a seamless playback unit for buffering both the recorded data distributed by said stream distribution unit and the recorded data recorded by said recording unit, and for continuously playing back them.

7. The video distribution system according to claim 1, wherein said receiver includes a leftover band detecting unit for measuring a use status of the network, and for performing control of the download of the recorded data distributed from the download distribution unit when detecting existence of a leftover band in said network.

8. The video distribution system according to claim 2, wherein said receiver includes a leftover band detecting unit for measuring a use status of the network, and for performing control of the download of the recorded data distributed from the download distribution unit when detecting existence of a leftover band in said network.

9. The video distribution system according to claim 3, wherein said receiver includes a leftover band detecting unit for measuring a use status of the network, and for performing control of the download of the recorded data distributed from the download distribution unit when detecting existence of a leftover band in said network.

10. The video distribution system according to claim 1, wherein said video-recording and distribution apparatus includes a recorded data management unit for managing video-recording requests inputted from said recording unit, and, when the video-recording requests include video-recording requests in which their channels and recording time zones overlap one another, said recorded data management unit manages to store recorded data about a program associated with only one of said video-recording requests, and said recorded data management unit deletes recorded data which have been distributed to the download receiving unit.

11. The video distribution system according to claim 2, wherein said video-recording and distribution apparatus includes a recorded data management unit for managing video-recording requests inputted from said recording unit, and, when the video-recording requests include video-recording requests in which their channels and recording time zones overlap one another, said recorded data management unit manages to store recorded data about a program associated with only one of said video-recording requests, and said recorded data management unit deletes recorded data which have been distributed to the download receiving unit.

12. The video distribution system according to claim 3, wherein said video-recording and distribution apparatus includes a recorded data management unit for managing video-recording requests inputted from said recording unit, and, when the video-recording requests include video-recording requests in which their channels and recording time zones overlap one another, said recorded data management unit manages to store recorded data about a program associated with only one of said video-recording requests, and said recorded data management unit deletes recorded data which have been distributed to the download receiving unit.

13. A video-recording and distribution apparatus wherein said apparatus comprises:
a recording control unit for recording a distributed program according to either a recording start request or a recording end request inputted from an external device;
a storage unit for storing recorded data about the distributed program which are recorded by said recording control unit; and
a download distribution unit for distributing said recorded data stored in said storage unit according to a download distribution request inputted from said external device.

14. A receiver comprising:
a stream receiving unit for receiving a program distributed to said receiver;
a playback unit for playing back said distributed program received by said stream receiving unit;
a recording unit for recording said distributed program received by said stream receiving unit;
a download receiving unit for downloading recorded data from an external device;
a storage unit for storing recorded data about said distributed program which are recorded by said recording unit and the recorded data downloaded by said download receiving unit; and
a recorded data reading unit for reading said recorded data stored in said storage unit, wherein,
when playing and recording a plurality of programs distributed to said receiver, said playback unit receives one of the plurality of programs distributed, said recording unit outputs either a recording start request to start recoding another one of the plurality of programs or a recording end request to end the recoding of the other one of the plurality of programs to the external device, and said download receiving unit outputs a download start request to start downloading said other program to said external device and receives recorded data about said other program after said playback unit ends the reception of said one of the plurality of programs distributed.
